(19) United States
(12) Patent Application Publication
(10) Pub. No.: US 2023/0298027 A1
(43) Pub. Date: Sep. 21, 2023

(54) IDENTITY AUTHENTICATION

(71) Applicant: GENERAL IDENTITY PROTOCOL LIMITED, Auckland (NZ)

(72) Inventor: Alan John Mayo, Auckland (NZ)

(73) Assignee: GENERAL IDENTITY PROTOCOL LIMITED, Auckland (NZ)

(21) Appl. No.: 18/041,389

(22) PCT Filed: Aug. 13, 2021
(86) PCT No.: PCT/NZ2021/050130

§ 371 Date: Feb. 10, 2023

(30) Foreign Application Priority Data
Aug. 13, 2020 (NZ) 767110

(51) Int. Cl. G06Q 20/40; G06Q 20/02; G06Q 20/32

(52) U.S. Cl. CPC G06Q 20/40145; G06Q 20/02; G06Q 20/3255; G06Q 20/3274

(57) ABSTRACT

A networked identity authentication system is provided for authenticating an identity of an actor to a transacting party based on a pre-existing relationship between the actor and an identifying party. The transacting party and identifying party are each in secure communication with an intermediary party. The intermediary party issues a dynamic identifier to one of the transacting party and identifying party. The dynamic identifier is provided to the actor, who is authenticated by the identifying party. The actor presents the dynamic identifier to the other of the transacting party and identifying party, which sends the dynamic identifier to the intermediary party. The intermediary party authenticates the identity of the actor to the transacting party if the received dynamic identifier matches the dynamic identifier which it previously issued.

### CROSS-REFERENCE TO RELATED APPLICATIONS

This application claims priority from New Zealand Patent Application No. 767110, filed Aug. 13, 2020, which is incorporated herein by reference in its entirety.

### BACKGROUND

It is frequently necessary for a person to identify themselves to an entity (for example, a company, authority or other organization) and authenticate their identity to provide some assurance to the entity that the person is indeed who they say they are. This may involve presentation of an accepted form of identification document issued to the person by the entity themselves or a trusted third party. Photographic identification such as a driver’s license or passport are example forms of photographic identification commonly accepted by a wide range of parties.

Simple forms of identification are prone to fraud using stolen, forged or doctored identification documents, particularly for online transactions where visual inspection of the original identification document and visual identification of the person may not be practical.

Some entities may also require additional documentation as further evidence of the person’s identity, particularly when a person initially interacts with an entity to open an account. For example, the entity may require both a form of photographic identification and a letter or invoice from a utility company or bank confirming the person’s name and address.

Particular identification requirements may be imposed by legislation, such as laws intended to counter money laundering and financing of terrorism.

For online transactions, identification is usually performed by the person creating an account with the entity, with access limited by a combination of a unique username (which may be, for example, the person’s email address, an identification or membership number, or an alphanumeric string) and a password which nominally known only to the person and the entity. A username and password combination is one example of a “static identifier,” as it will generally remain useable for a relatively long period of time (typically months, or even years), and may be used for more than one transaction between the person and the entity. Although generally discouraged, it is also common for a person to reuse the same username and/or password with multiple entities. The static identifier therefore presents a security risk if the password becomes known to others.

As security has become more of a concern, additional credentials are increasingly required to complete an authentication (multi-factor authentication or MFA). Biometrics have been used as a more sophisticated type of static identifier authenticating a person’s identity.

In many cases, identification of the person is conducted directly between the person and the relevant entity. No identity information is shared with, or by, the entity with any other entity. A person may therefore be required to repeat the identification and authentication steps with each of a number of different entities, which can be a considerable inconvenience.

It is an object of the present disclosure to provide systems and methods which overcome or ameliorate one or more disadvantages of the prior art, including but not limited to those set out above, or alternatively to at least provide the public or industry with a useful alternative.

### BRIEF SUMMARY

In a first aspect, there is provided a networked identity authentication system for authenticating an identity of an actor to a transacting party based on a pre-existing relationship between the actor and an identifying party. The networked identity authentication system includes a transacting party server of the transacting party, an identifying party server of the identifying party, and an intermediary party server of an intermediary party in secure network communication with the transacting party server and the identifying party server. Each of the transacting party server, identifying party server and intermediary party server include a respective processor, memory and network interface. The processor of at least one of the transacting party server and the identifying party server is configured to: request, via the respective network interface, a dynamic identifier from the intermediary party server; receive, via the respective network interface, the dynamic identifier from the intermediary party server; and provide the dynamic identifier to the actor. The processor of at least the other of the transacting party server and the identifying party server is configured to: receive an identifier from the actor; and send, via the respective network interface, the identifier to the intermediary party server. The processor of the identifying party server is further configured to authenticate the actor based on the pre-existing relationship between the actor and the identifying party. The processor of the transacting party server is further configured to: receive, via the respective network interface, confirmation of authentication from the intermediary party server. The processor of the intermediary party server is configured to: receive a request for the dynamic identifier from a requestor, the requestor being one of the transacting party server and the identifying party server, and a non-requestor being the other of the transacting party server and the identifying party server; select the dynamic identifier; store the dynamic identifier in the memory of the intermediary party server; send, via the respective network interface, the dynamic identifier to the requestor; receive, via the respective network interface, the identifier from the non-requestor; authenticate the identifier received from the non-requestor by comparing it with the stored dynamic identifier; and send, via the respective network interface, the confirmation of authentication to the transacting party server if the identifier matches the stored dynamic identifier.

The processor of the at least one of the transacting party server and the identifying party server may be further configured to receive a request for a dynamic identifier from the actor.

The processor of the identifying party server may be configured to: request the dynamic identifier from the intermediary party server, receive the dynamic identifier from the intermediary party server, and provide the dynamic identifier to the actor. The processor of the transacting party server may be configured to receive the identifier from the actor, and send the identifier to the intermediary party server. The processor of the intermediary party server may be configured to receive the request for the dynamic identifier from the identifying party server, send the dynamic identifier to the identifying party server, and receive the identifier from the transacting party server.

Alternatively, or additionally, the processor of the transacting party server may be configured to request the dynamic identifier from the intermediary party server, receive the dynamic identifier from the intermediary party server, and provide the dynamic identifier to the actor. The processor of the identifying party server may be configured to receive the identifier from the actor, and send the identifier to the intermediary party server. The processor of the intermediary party server may be configured to receive the request for the dynamic identifier from the transacting party server, send the dynamic identifier to the transacting party server, and receive the identifier from the identifying party server.

The processor of the transacting party server may be further configured to: request, via the respective network interface, additional data from the intermediary party server; and receive, via the respective network interface, the additional data from the intermediary party server. The processor of the intermediary party server may be further configured to: receive, via the respective network interface, the request for the additional data from the transacting party server; request, via the respective network interface, the additional data from the identifying party server; receive, via the respective network interface, the requested additional data from the identifying party server; and send, via the respective network interface, the additional data to the transacting party server. The processor of the identifying party server is further configured to: receive, via the respective network interface, the request for the additional data from the intermediary party server; retrieve the additional data from the memory of the identifying party server; and send, via the respective network interface, the additional data to the intermediary party server.

The request for the additional data from the intermediary party server may be combined with the request for the dynamic identifier from the intermediary party server.

Sending the received additional data to the transacting party server may include sending the confirmation of authentication of the identity of the actor.

The additional data may include one or more of the actor’s security level, authorization rights, access privileges, age entitlements, legal name, address, bank account number, medical status, telephone number, email address, birthdate, driver’s license number, and passport number.

The processor of the intermediary party server may be configured to authenticate the received identifier only if the identifier is received within a specified period from selecting, storing or sending the dynamic identifier.

The processor of the intermediary party server may be further configured to: store a timestamp in the memory of the intermediary party server upon storing the dynamic identifier; and upon receiving the identifier from the non-requestor, determine whether the identifier was received within the specified period of the timestamp.

The specified period may vary from one transaction to another.

The specified period may be dependent on a type or value of a particular transaction between the actor and the transacting party.

The processor of the intermediary party server may be configured to select the dynamic identifier by randomly generating at least a portion of the dynamic identifier.

The processor of the intermediary party server may be configured to generate the dynamic identifier as one or more of a character string, graphic, audible sound, and physical object.

The processor of the intermediary party server may be configured to select a dynamic identifier which is practically unique and not easily guessable.

The processor of at least one of the transacting party server, the identifying party server and the intermediary party server may be configured to encode the dynamic identifier as a machine-readable optical symbol for presentation to the actor via a display or printer of at least one of the transacting party server or the identifying party server.

The processor of at least one of the transacting party server, the identifying party server and the intermediary party server may be configured to decode the identifier from the machine-readable optical symbol received from an optical sensor of at least one of the transacting party server or the identifying party server.

The machine-readable optical symbol may be a Quick Response (QR) code or Universal Product Code (UPC) barcode.

The dynamic identifier may be a numeric code. The processor of at least one of the transacting party server and the identifying party server may be configured to provide the numeric code to the actor. The processor of at least the other of the transacting party server and the identifying party server may be configured to decode the numeric code from at least one of a voice signal or a dual tone multi frequency (DTMF) signal received from the actor via a telecommunications network.

The transacting party and the identifying party may be a single party, and/or the transacting party server and the identifying party server may be a single server. A processor of the single party and/or single server may be configured to provide the dynamic identifier to the actor and receive the identifier from the actor via two different channels.

The two different channels include any two of: voice communication via a telecommunication network, voice communication in person, voice communication via radio communication, data communication with a computing device of the actor, short message service (SMS) message, physical mail, e-mail, and social media.

The processor of the intermediary party server may be further configured to check for compliance with one or more further criteria before sending the confirmation of authentication of the identity of the actor to the transacting party server.

The one or more further criteria may relate to one or more of: channel type, a format of the dynamic identifier, device type, timeframe, sub-location, purpose, and value.

The one or more further criteria may vary for each transaction.

The processor of the intermediary party server may be further configured to perform additional identity checks.

The processor of the intermediary party server may be further configured to compare selected actor profile data stored by each of the transacting party server and the identifying party server.

The processor of the intermediary party server may be further configured to monitor operation of the networked identity authentication system to identify an attempt to subvert security of the networked identity authentication system.

The processor of the intermediary party server may be configured to monitor operation of the networked identity authentication system by identifying one or more of: re-use of a dynamic identifier, a fake identifier, or a guessed identifier.

The networked identity authentication system may be configured to operate in a synchronous mode.

Alternatively, or additionally, the networked identity authentication system may be configured to operate in an asynchronous mode.

The networked identity authentication system may include a plurality identifying parties.

The networked identity authentication system may include a plurality of transacting parties.

The processor of the intermediary party may be configured to maintain anonymity of the actor with respect to the transacting party.

The processor of the identifying party server may be configured to authenticate the actor based on the pre-existing relationship between the actor and the identifying party by biometric authentication.

The processor of the intermediary party server may be further configured to store relationship details between the actor’s account with a first party and the actor’s account with a second party in the memory of the intermediary party server.

The processor of the intermediary party server may be further configured to receive a bill for the actor from a first party and send the bill to the second party in accordance with the stored relationship details.

The intermediary party server may be further configured to receive a message from the first party and send the message to the second party in accordance with the stored relationship details.

The networked identity authentication system, further including a data server of a trusted data party in secure network communication with the intermediary party server. The processor of the intermediary party server may be configured to: request, via the respective network interface, additional data from the data server; receive, via the respective network interface, the additional data from the trusted data server; and send, via the respective network interface, the additional data to the transacting party server.

In a second aspect, there is provided an intermediary party server for use in a multi-party networked identity authentication system. The intermediary party server includes a processor, a memory, and a network interface. The memory includes a non-transitory computer-readable storage medium including instructions that, when processed by a computer, configure the intermediary party server to select a dynamic identifier, store the dynamic identifier in the memory, send the dynamic identifier to a first party via the network interface, receive an identifier from a second party via the network interface, compare the identifier with the dynamic identifier stored in the memory, and send an authentication message to at least one of the first party or the second party if the identifier matches the dynamic identifier.

The processor may be further configured to determine whether the identifier was received within a specified period from selecting, storing, or sending the dynamic identifier; and send the authentication message only if the identifier matches the dynamic identifier and the identifier was received within the specified period.

The processor may be further configured to select the dynamic identifier by randomly generating at least a portion of the dynamic identifier.

The first party may be an identifying party responsible for authenticating an actor before providing the dynamic identifier to the actor. The second party may be a transacting party responsible for receiving the identifier from the actor and sending the identifier to the intermediary party server for authentication. The processor may be configured to send the authentication message to the transacting party.

Alternatively, or additionally, the first party may be a transacting party responsible for providing the dynamic identifier to an actor, and the second party may be an identifying party responsible for authenticating the actor, receiving the identifier from the actor and sending the identifier to the intermediary party server. The processor may be configured to send the authentication message to the transacting party.

In a third aspect, there is provided a method for authenticating an identity of an actor to a first party based on a pre-existing relationship between the actor and a second party. The method including steps of receiving a request for a dynamic identifier from a requestor, the requestor being one of the first party or the second party and a non-requestor being the other of the first party or the second party; selecting the dynamic identifier; recording the selected dynamic identifier; sending the selected dynamic identifier to the requestor; receiving an identifier from the non-requestor; determining whether the identifier received from the non-requestor matches the recorded dynamic identifier; and authenticating the identity of the actor to the first party if the identifier received from the non-requestor matches the selected dynamic identifier sent to the requestor.

The method may further include a step of determining whether the identifier received from the non-requestor was received within a specified period from at least one of the steps of receiving the request for the dynamic identifier, selecting the dynamic identifier, recording the dynamic identifier, or sending the dynamic identifier.

The step of selecting the dynamic identifier may include randomly generating at least a portion of the dynamic identifier.

The step of selecting the dynamic identifier may include confirming either the selected dynamic identifier is not in active use, or the dynamic identifier has not previously been used.

The requestor may be the first party and the non-requestor may be the second party.

Alternatively, or additionally, the requestor may be the second party and the non-requestor may be the first party.

Other technical features may be readily apparent to one skilled in the art from the first and second aspects, and the following figures, descriptions, and claims.

In a fourth aspect, there is provided a method for authenticating an identity of an actor to a transacting party in communication with an intermediary party. The method includes steps of: authenticating the actor, requesting a dynamic identifier from the intermediary party, receiving the dynamic identifier selected by the intermediary party, and providing the received dynamic identifier to the actor. The identity of the actor can be authenticated to the transacting party by the actor presenting the dynamic identifier to the transacting party, the transacting party sending the presented dynamic identifier to the intermediary party, and the intermediary party determining whether the dynamic identifier received from the transacting party matches the dynamic identifier selected by the intermediary party.

Other technical features may be readily apparent to one skilled in the art from the first aspect and the following figures, descriptions, and claims.

In a fifth aspect there is provided a method for authenticating an identity of an actor to a transacting party in communication with an intermediary party. The method includes steps of: authenticating the actor, receiving a dynamic identifier from the actor, sending the dynamic identifier received from the actor to the intermediary party for authentication of the actor to the transacting party by the intermediary party if the dynamic identifier received from the actor matches an identifier previously issued by the intermediary party to the transacting party.

Other technical features may be readily apparent to one skilled in the art from the first aspect and the following figures, descriptions, and claims.

In a sixth aspect, there is provided a method for authenticating an identity of an actor based on a pre-existing relationship between the actor and an identifying party in communication with an intermediary party. The method includes steps of: receiving a dynamic identifier from the actor, sending the dynamic identifier received from the actor to the intermediary party, and receiving authentication of the identity of the actor from the intermediary party if the dynamic identifier matches an identifier previously issued by the intermediary party to the identifying party following authentication of the actor by the identifying party.

Other technical features may be readily apparent to one skilled in the art from the first aspect and the following figures, descriptions, and claims.

In a seventh aspect, there is provided a method for authenticating an identity of an actor based on a pre-existing relationship between the actor and an identifying party in communication with an intermediary party. The method includes steps of requesting a dynamic identifier from the intermediary party, receiving the dynamic identifier selected by the intermediary party, providing the dynamic identifier received from the intermediary party to the actor, and receiving authentication of the identity of the actor from the intermediary party following the identifying party authenticating the actor and forwarding the dynamic identifier received from the actor to the intermediary party, if the intermediary party determines that the dynamic identifier received from the identifying party matches the dynamic identifier previously selected by the intermediary party.

In an eighth aspect, there is provided a non-transitory computer-readable storage medium including instructions that, when processed by a computer, configure the computer to perform the method of any one of the third to seventh aspects.

In a ninth aspect, there is provided a computing apparatus including a processor and a memory storing instructions that, when processed by a computer, configure the computing apparatus to perform the method of any one of the third to seventh aspects.

### BRIEF DESCRIPTION OF THE DRAWINGS

The present technology will be described below with reference to the non-limiting examples of the accompanying drawings. To easily identify the discussion of any particular element or act, the most significant digit or digits in a reference numeral refer to the figure number in which that element is first introduced.

FIG. 1 illustrates an I-type architecture for identifying an actor.

FIG. 2 illustrates an L-type architecture for identifying an actor.

FIG. 3 illustrates a U-type architecture for identifying an actor.

FIG. 4 illustrates an O-type architecture for identifying an actor.

FIG. 5 illustrates a topology of an identity authentication system according to an embodiment of the present technology.

FIG. 6 illustrates a first embodiment of a message protocol according to the present technology.

FIG. 7 illustrates a sequence diagram for the message protocol of FIG. 6.

FIG. 8 illustrates a routine 800 performed by an intermediary party for authenticating an identity of an actor to a first party based on a pre-existing relationship between the actor and a second party in accordance with one embodiment.

FIG. 9 illustrates a routine 900 performed by an identifying party according to the message protocol of FIG. 6.

FIG. 10 illustrates a routine 1000 performed by a transacting party for authenticating an identity of an actor based on a pre-existing relationship between the actor and an identifying party according to the message protocol of FIG. 6.

FIG. 11 illustrates a second embodiment of a message protocol according to the present technology.

FIG. 12 illustrates a sequence diagram for the message protocol of FIG. 11.

FIG. 13 illustrates a routine 1300 performed by an identifying party according to the message protocol of FIG. 11.

FIG. 14 illustrates a routine 1400 performed by a transacting party according to the message protocol of FIG. 11.

FIG. 15 illustrates a networked identity authentication system according to an embodiment of the present technology.

FIG. 16 illustrates an embodiment of a graphic which may form a dynamic identifier according to an embodiment of the present technology.

FIG. 17 illustrates an embodiment of on-behalf message switching according to the present technology.

FIG. 18 illustrates another embodiment of on-behalf message switching according to the present technology.

FIG. 19 illustrates a topology of an identity authentication system including trusted data parties, in accordance with a further embodiment of the present technology.

FIG. 20 illustrates a third embodiment of a message protocol according to the present technology.

### DETAILED DESCRIPTION

At a conceptual-level, identity authentication is possible at three levels: centralized, distributed, and ecosystem solutions. The first is not politically appealing in democratic countries with citizen rights, and the difficulty of securing personal information and communications technology (ICT) devices (such as smartphones, tablets and personal computers) makes the second option challenging. The present disclosure provides an ecosystem approach which is suitable for use in multiple fields including banking, insurance, retailing, entertainment, sports, local government, central government, and health.

Throughout the detailed description, the various participants are termed “actors” and “parties” for convenience. An “actor” may be a natural person, a person representing a legal entity such as a company, or a technology that represents a person or a legal entity, and is the participant who is being identified and authenticated. A “party” is a participant that provides services to actors, and is generally a company or other organization. Depending upon their role in a particular transaction, the actor is either identified to the party, or identified by the party. As described in further detail below, the party may be a transacting party, an identifying party or, in some embodiments, a trusted data party.

The disclosed system supports three classes of identity transactions (ITs): permission, account and relationship. Each of these classes is based upon the identification and the authentication of an actor. Identity permission transactions (IPT) authenticate an actor’s professed identity in order to then check the actor’s permissions to perform some act. Such acts include access to a resource, access to a service or authorizing some action. Identity account transactions (IATs) authenticate an actor’s professed identity in order to then perform some account-based acts such as opening a new account. Identity relationship transaction (IRTs) create relationships between parties on behalf of actors.

Identity transactions can be single-party or multi-party. Single-party scenarios are occur when an actor wishes to authenticate themselves with a party, for example a bank. Multi-party situations are those in which an actor is seeking to authenticate themselves with a new party based upon an established relationship with another party. The disclosed technology provides for sharing identity information between organizations at a customer’s behest. The disclosed systems are primarily aimed at multi-party identity transactions but are also applicable within a single-party scenario, as described in further detail below.

Identity transactions operate in many channels including in-person, on-telephone, on-line (such as on or via computers), and combinations of these. For online transactions in particular, static identifiers are widely used. These are often a combination of a username and a password. The username (which may be an email address, for example) is generally unique to the actor, while the password is nominally known only to the actor and the party and is used to authenticate the actor. More recently, biometric authentication has been developed as a more sophisticated type of static identifier.

In general, there are four potential architectures for an identification system: I-type, L-type, U-type and O-type.

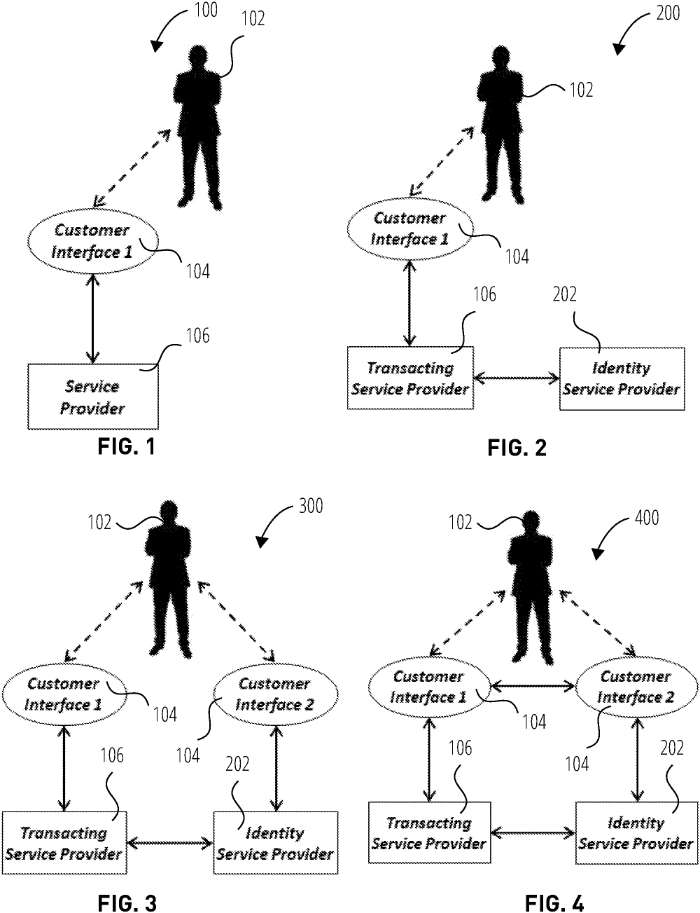

Referring first to FIG. 1, there is shown an I-type architecture 100 for identification of an actor 102 by a transacting party 106. The actor 102 interacts directly with the transacting party 106 via a customer interface 104. This is a single-party scenario of one actor and one party.

Without limitation, the customer interface 104 may be a point-of-sale device belonging to the transacting party 106, or it may be an application (“app”) or webpage having a graphical user interface (GUI) presented on a computing device such as a smartphone, tablet, personal computer or the like belonging to the actor.

Referring to FIG. 2, there is shown an L-type architecture. Like the I-type architecture 100 of FIG. 1, the actor 102 interacts directly with the transacting party 106 via customer interface 104. However, identification is performed by an identifying party 202 who communicates with the transacting party 106. An example might be the actor logging into an online retailer, as the transacting party 106, using their login details for a popular social media service, as the identifying party 202. A further example of this L-type architecture is the RealMe^{®} single sign-on (SSO) initiative of the New Zealand government, which provides a single set of login details which may be used for a range of government services online.

By their very nature, L-type solutions are generally restricted to online channels as the static identifiers and credentials used cannot be confidentiality communicated over physical channels (i.e., a password cannot be securely communicated over the telephone). Besides this functional limitation, the L-type architecture is susceptible to so-called “phishing” attacks fraudulently inducing a person to give up their personal information. As an identifying party’s services become more widely used by various transacting parties, the static identifier become more valuable and phishing attacks can be expected to become more prevalent.

Referring to FIG. 3, a U-type architecture 300 is shown. In this architecture, the actor 102 communicates with each of the transacting party 106 and identifying party 202 through different channels and respective customer interfaces 104. An example is the Swedish BankID™, in which a person logs onto a pharmacy website and then authenticates themselves through a bank-provided smartphone app. This solution appeals as a strong authentication can be obtained through the bank, possibly using biometric authentication. However, it is vulnerable to social engineering attacks. For example, a bank customer may be convinced to authenticate on a smartphone and enable a criminal to then gain access to their bank account. This is a problem of the U-type architecture 300 not being able to guarantee co-location of the two channels being utilized by the actor 102. In other words, there is no certainty that a single person is communicating with both the transacting party 106 and the identifying party 202.

Referring to FIG. 4, there is shown an O-type architecture 400. In this architecture, after an initial U-type authentication, a confirmation code is communicated by the actor from one channel to the other, thereby indicating there is a single actor involved in the transaction. This architecture provides a static identifier/dual interactions solution. The problem with this O-type architecture is that it is relatively complex and inconvenient for customers as two interactions are required that involve both parties.

There are additional issues for the three multi-party scenarios (i.e., the L-, U-, and O-type architectures) with the use of static identifiers. The first issue is that static identifiers enable fraud, attempted fraud, and disruption. Knowledge of a static identifier gives the potential to achieve fraud (through a provider with insufficient security), to attempt fraud (e.g., by password guessing), and cause disruption (repeated brute force attacks). Hence, there is motivation to steal static identifiers (in a similar manner to how credit card numbers are stolen). Secondly, an actor’s privacy is not protected. There is no such thing as anonymity when using many ICT-based solutions (i.e., data from multiple systems can be combined to track individuals), and using a unique identifier such as an email address or tax number clearly makes it possible to determine who an actor is. While this may often not be an issue, for such things as a COVID-19 health passport check at a cinema, it may be preferred that an actor is not identifiable by the cinema (whereas the same check when executed by the police may necessitate giving the actor’s name).

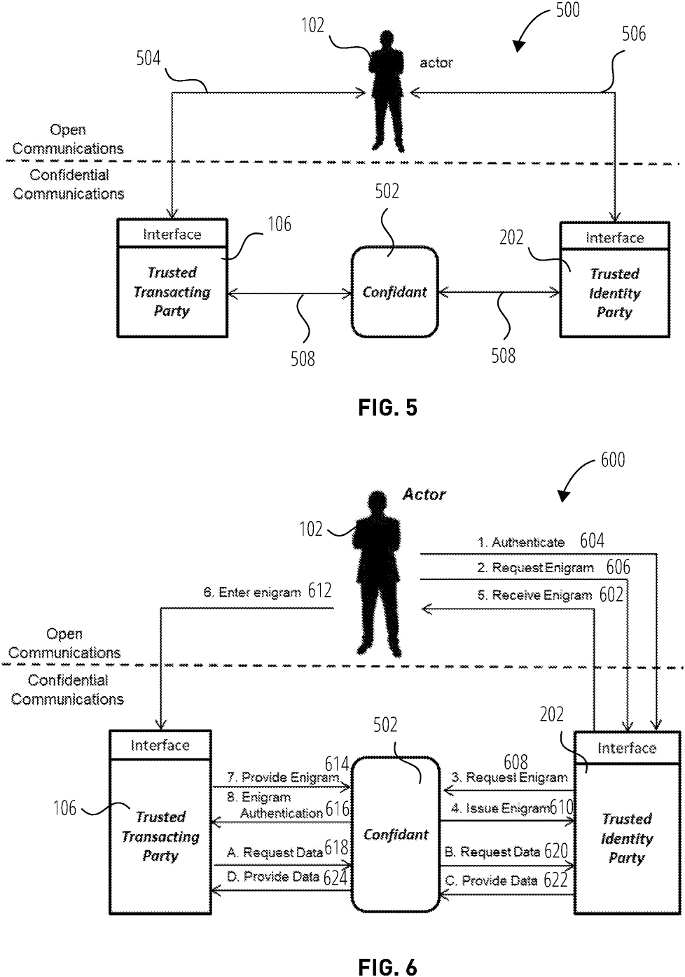

An embodiment of a topology for an identity authentication system 500 according to the present technology is illustrated in FIG. 5. The identity authentication system 500 uses a variant of the O-type architecture 400, with a dynamic identifier and a single interaction. The identity authentication system 500 includes:
an intermediary party
secure back-end network for communication between the parties,
use of a single actor biometric authentication,
a message protocol, and
a dynamic identifier.

### Topology

The illustrated identity authentication system 500 includes an actor 102, a transacting party 106, an identifying party 202 and an intermediary party 502. In practice, there may be any number of actors 102, transacting parties 106, and/or identifying parties 202. A single actor 102, transacting party 106 and identifying party 202 are illustrated in FIG. 5 for convenience.

The actor 102 is in communication with the transacting party 106 via a first communication channel 504 and the identifying party 202 via a second communication channel 506. The first communication channel 504 and second communication channel 506 may each be, at least in part, open in the sense that the communication need not necessarily be confidential. However, it is to be appreciated that the channels may optionally be secure without departing from the spirit or scope of the disclosure.

The transacting party 106 and identifying party 202 are each in confidential communication with the intermediary party 502 via a secure back-end network 508. The back-end network 508 may be, in part or in whole and without limitation, a local area network (LAN), wide area network (WAN), Internet and combinations thereof, whether wired and/or wireless. In other embodiments, the confidential communications between the transacting party 106, intermediary party 502 and identifying party 202 need not necessarily occur synchronously or be via a data communication network. By way of non-limiting example, an identity authentication system according to alternative embodiments of the present disclosure could alternatively or additionally use postal mail, courier, telex or the like for communication between the transacting party 106 and the intermediary party 502, and/or between the identifying party 202 and the intermediary party 502 in certain applications not requiring real-time authentication.

### Intermediary Party

The intermediary party 502 is trusted by each of the transacting party 106 and the identifying party 202. The intermediary party 502 may have a contractual relationship with each transacting party 106 and each identifying party 202. The transacting party 106 and identifying party 202 do not necessarily have a contractual relationship with, or even knowledge of, each other.

The intermediary party 502 may be any type of intelligent entity with the ability to create, remember and compare. Often it will be a computer system. The intermediary party’s functions include:
administering dynamic identifiers,
configuring dynamic identifiers and identity transactions,
performing any additional identity checks, and
monitoring usage of the identity authentication system 500.

Administering dynamic identifiers involves issuing, remembering and checking dynamic identifiers. When issuing dynamic identifiers, the intermediary party ensures that the intermediary party is not easily guessable. This is achieved by having a significantly greater number of possible dynamic identifier permutations that can be used in a dynamic identifier’s life span, and random algorithms to avoid any pattern to the dynamic identifier values selected for use.

Configuring dynamic identifiers and identity transactions involves administering configurations that have been agreed with the parties. Configurable transaction attributes include:
channel types - some transactions will optionally have limited channels that they can be executed in. For example, a transaction may be restricted to a smartphone with QR code or NFC scanning abilities.
timeframe - the transaction may optionally only operate in certain hours of the day, or days of the week.
sub-locations - when the transacting party represents a network of sub-locations (e.g., retail stores), a transaction may optionally be limited for use at only a single sub-location or a group of sub-locations.
purpose - a transaction may optionally have restricted purpose(s).
value - optional transaction maximum or minimum values the identity transaction can authorize.

The configuration of a dynamic identifier and a transaction, either for all executed transactions or selected individual transactions, enables a balance to be struck between transaction complexity and situation risk. Depending on the circumstances (including channel, transaction value, parties, and actor), a transaction and dynamic identifier can be configured to ensure appropriate levels of identity transaction security. By constraining the scope of where, when, and how a dynamic identifier can be used, the risk profile of that use is also explicitly constrained.

The configuration options for dynamic identifiers and for identity transactions will normally be agreed in advance by the intermediary party 502 with the identifying party 202 and/or transacting party 106, but in some embodiments they may be varied transaction by transaction. In such cases, flexible message formatting is used to indicate the option being used in a particular transaction.

The intermediary party may perform additional identity checks when an actor has a profile with both the identity transaction and the transacting party. In such cases data matching can be used as an additional check which leads to exception raising and/or reporting that leads to further investigation.

Lastly, the intermediary party 502 may monitor the overall operation of the identity authentication system to identify any systemic behavior which may indicate attempts to subvert the security of the system. Given that the dynamic identifiers are single-use and often machine-readable, any subversive attacks may be easier to recognize as compared to attacks on systems that use a username and password combination, for example. The ability to recognize many attacks also allows for the identification of different patterns of attack and any bad actors working within the system.

### Message Protocol

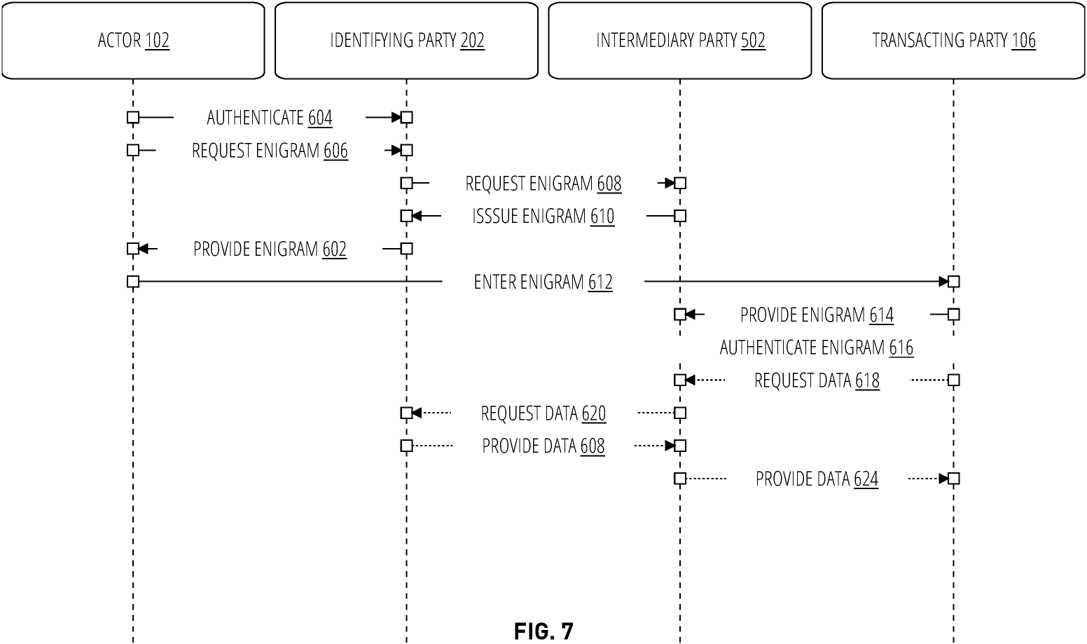

A message protocol 600 according to a first embodiment is illustrated in FIG. 6 (overlaid on the topography of FIG. 5) and FIG. 7 (in sequence diagram form).

In a first step 604 the actor 102 authenticates their identity with the identifying party 202, with whom they have a pre-existing relationship. The authentication step may use biometric authentication. “Biometric authentication” refers to any of a range of methods for reliably identifying a person by way of a characteristic of the person and includes, without limitation, fingerprint, palm vein, face, DNA, palm print, hand geometry, iris, retina and voice recognition, or combinations thereof. By way of non-limiting example, the authentication step may use a fingerprint sensor of a computing device belonging to the actor, by way of a smartphone app provided to the actor 102 by the identifying party 202.

In a second step 606, the actor 102 requests a dynamic identifier, which in the drawings is referred to as an “Enigram″™, from the identifying party 202.

In a third step 608, the identifying party 202 in turn requests a dynamic identifier from the intermediary party 502, which in FIG. 6 is referred to as a “Confidant”.

In a fourth step 610, the intermediary party 502 issues a dynamic identifier to the identifying party 202. This may involve selecting a suitable dynamic identifier, recording it for later reference, and sending it to the identifying party 202.

In a fifth step 602 the identifying party 202 receives the dynamic identifier from the intermediary party 502 and provides it to the actor 102. This can be by any method including the actor 102 optically scanning a Quick Response (QR) code or Universal Product Code (UPC) barcode, entering a value, or photographing a rebus displayed by the identifying party 202, using near-field communication (NFC), or receiving an email, short message service (SMS), postal mail, carrier pigeon or the like from the identifying party 202. If, for example, the dynamic identifier is presented as a QR code to be scanned by the actor 102, the identifying party 202 may be configured to encode an alphanumeric dynamic identifier received from the intermediary party 502 as a QR code, or the intermediary party 502 may encode the dynamic identifier as a QR code and send the QR code image to the identifying party 202 for displaying or forwarding to the actor 102.

In a sixth step 612, the actor 102 provides the dynamic identifier to the transacting party 106 via a different channel. By way of non-limiting example, if the dynamic identifier is obtained from the identifying party 202 as a QR code image over a telecommunications network, the QR code may be physically presented on the smartphone’s display to an optical sensor at the premises of the transacting party 106. The transacting party 106 may therefore decode an alphanumeric dynamic identifier from the QR code image presented by the actor 102.

In a seventh step 614, the transacting party 106 sends the dynamic identifier received from the actor 102 to the intermediary party 502 for authentication. If the dynamic identifier received by the intermediary party 502 does not match a dynamic identifier previously issued to a transacting party 106, authentication is denied. Otherwise, the system proceeds to the eighth step 616.

In an eighth step 616, the intermediary party 502 sends confirmation of authentication to the transacting party 106.

The message protocol 600 achieves three functions through the use of the single dynamic identifier communicated between the identifying party 202 and the transacting party 106, via the actor 102 - identification, authentication and single actor. The dynamic identifier is proof that the actor 102 has been identified and securely authenticated by the identifying party 202. Receipt and entry of a valid dynamic identifier by the actor 102 is proof that the actor 102 has accessed both the transacting party 106 and the identifying party 202.

If data is required to complete an identity transaction, the identity authentication system 500 may optionally perform additional data request steps.

In a first step 618 the transacting party 106 requests data from the intermediary party 502.

In a second step 620, the intermediary party 502 requests the data from the identifying party 202.

In a third step 622, the identifying party 202 provides the requested data to the intermediary party 502.

In a fourth step 624, the intermediary party 502 provides the received data to the transacting party 106.

It will be apparent to those skilled in the art that some of the above steps may be combined in a single message. For example, the first step 604 and the second step 606 of the authentication method may be combined in a single message, and data request steps 618, 620, 622, 624 may be combined with appropriate steps of the authentication method as will be apparent to those skilled in the art. For example, the first step 618 of the data request method may be combined with the seventh step 614 of the authentication method, and/or the fourth step 624 of the data request method may be combined with the eighth step 616 of the authentication method.

For identity permission transactions that only require an authentication, extra messaging may not be required. For other identity permission transactions, the data returned may include actor information such as, without limitation, any one or more of the actor’s security level, authorization rights, access privileges, age entitlements, legal name, address, bank account number, medical status, telephone number, email address, birthdate, driver’s license number, and passport number. For identity account transactions, the data returned may include any combination of the actor’s profile information (for example, name, address, and bank account number when opening a utility account). For identity relationship transaction that create on-behalf relationships, data messaging can be used to exchange tokens to enable direct on-behalf transaction by the transacting party and identifying party, or alternatively the intermediary party may maintain the relationship on the actor’s behalf (as described in further detail below).

By way of non-limiting example, the message protocol 600 may involve an actor 102 using a smartphone app provided by a health authority (as the identifying party 202) request a dynamic identifier for access to a cinema (as the transacting party 106). The dynamic identifier would be delivered as a QR-code to the actor’s smartphone, for placement under an optical sensor which is used to control opening of a barrier to admit the actor 102 if their medical status (e.g., COVID-19 test result or vaccination status) was acceptable. A further example might involve the actor 102 using a banking app on their smartphone to request a dynamic identifier to provide their bank account details to a power utility. The actor 102 may convey an 8-digit code, received from their bank acting as the identifying party 202, over the telephone (by voice or dial pad, using dual tone multi frequency (DTMF) encoding and decoding) to the utility company’s call-center operator. When entered and checked, the power utility, as the transacting party 106, receives the account number from the bank via the intermediary party 502.

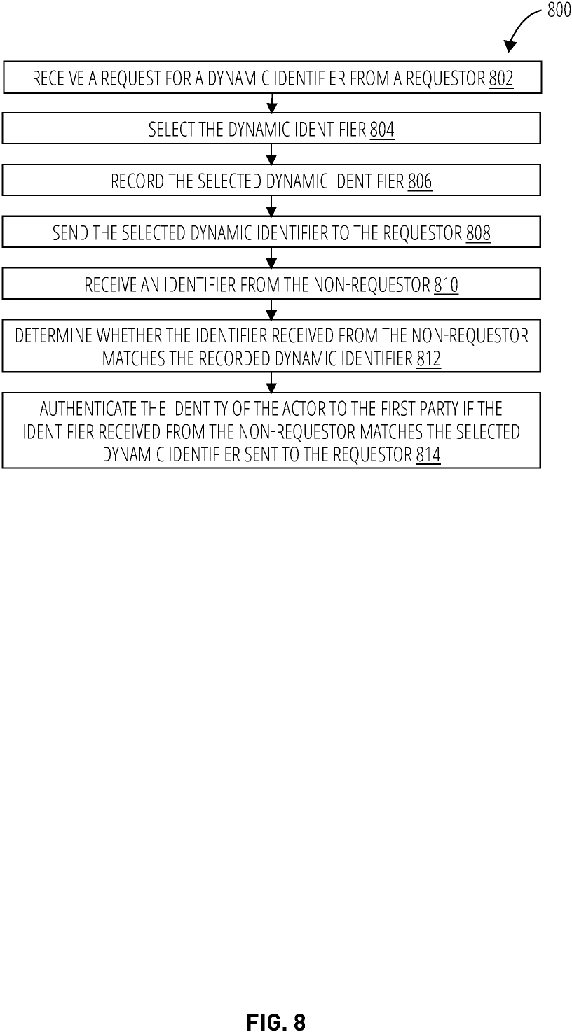

The method performed by the intermediary party 502, in the form of routine 800, is illustrated in the flowchart of FIG. 8.

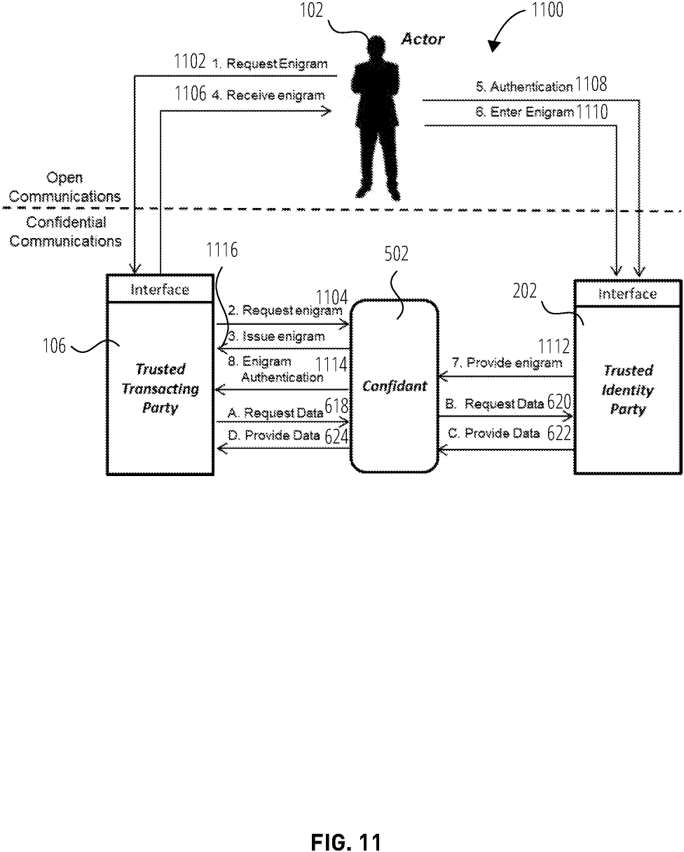

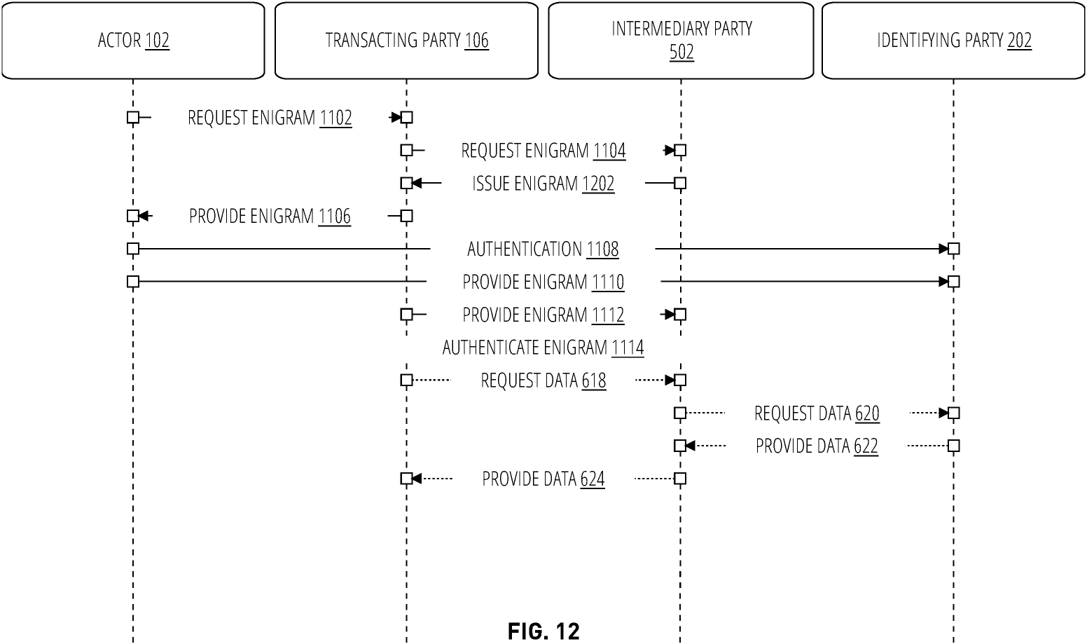

In block 802, routine 800 receives a request for a dynamic identifier from a requestor. The requestor is one of the transacting party 106 or the identifying party 202, and the other of the transacting party 106 and identifying party 202 is a non-requestor. In the first embodiment of FIG. 6 and FIG. 7, the identifying party 202 is the requestor and the transacting party 106 is the non-requestor. In the second embodiment of FIG. 11 and FIG. 12, described below, the transacting party 106 is the requestor and the identifying party 202 is the non-requestor.

In block 804, routine 800 selects the dynamic identifier. As described in further detail below, the dynamic identifier may be randomly generated, and is generally intended to be used for a single transaction, although in some embodiments dynamic identifiers may be reused. Block 804 may therefore further involve checking whether a randomly generated dynamic identifier has previously been used, or has been used within a predetermined preceding period, and generating an alternative dynamic identifier if necessary.

In block 806, routine 800 records the selected dynamic identifier. The dynamic identifier may be recorded along with other information, such as a timestamp recording when the dynamic identifier was generated, recorded, and/or sent.

In block 808, routine 800 sends the selected dynamic identifier to the requestor. As described elsewhere, the requestor may then provide the dynamic identifier to the actor to be presented to the non-requestor, whereupon the non-requestor sends the received identifier to the intermediary party for authentication.

In block 810, routine 800 receives an identifier from the non-requestor. For a legitimate transaction this is the identifier which the non-requestor receives from the actor, which the actor 102 has in turn received from the requestor after being sent to the requestor by the intermediary party 502 at block 808.

In block 812, routine 800 determines whether the identifier received from the non-requestor matches the dynamic identifier it previously generated in block 804, recorded in block 806, and sent to the requestor in block 808. Block 812 in this embodiment further involves determining whether the identifier received from the non-requestor meets any other applicable, such as whether or not it was received within a specified period following selection, recording, and/or sending of the dynamic identifier in blocks 804, 806, 808, respectively. This may be achieved by comparing the time of receipt with the timestamp recorded at block 806, and will determine compliance with the dynamic identifier’s life span. If the period elapsed between the timestamp and the time of receipt exceeds the life span of the dynamic identifier, the dynamic identifier has expired and authentication will be denied.

In block 814 routine 800 authenticates the identity of the actor to the transacting party 106 by sending a message accordingly. If at block 812 it is determined that the received identifier does not match a recorded dynamic identifier, or the matching dynamic identifier is determined to have expired, authentication will be denied and the transacting party 106 may be notified accordingly.

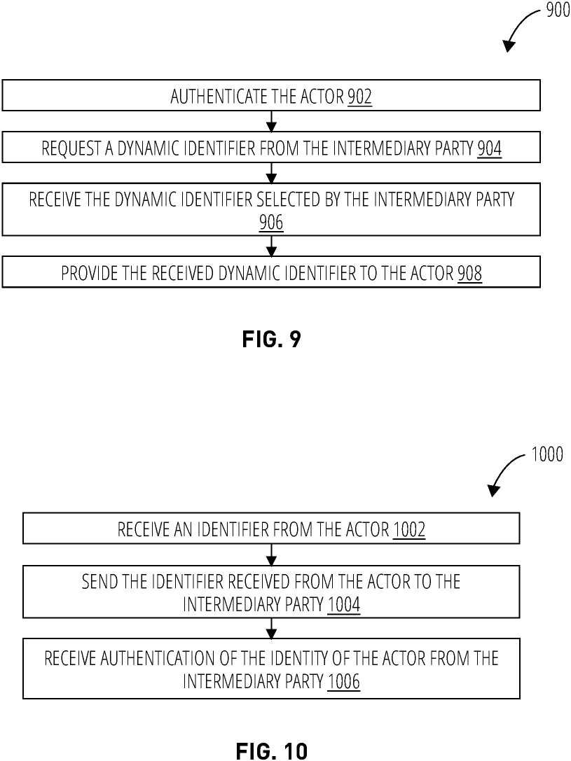

The method performed by the identifying party 202 according to the first embodiment of FIG. 6 and FIG. 7, in the form of routine 900, is illustrated in the flowchart of FIG. 9.

In block 902, routine 900 authenticates the actor. Because the identifying party 202 has a preexisting relationship with the actor 102, by way of non-limiting example this authentication may be a biometric authentication using an app provided to a smartphone or other computing device in possession of the actor 102 as described elsewhere. If the actor 102 cannot be authenticated, the routine 900 does not proceed to block 904, and an error message may be displayed to at least the actor 102.

In block 904, routine 900 requests a dynamic identifier from the intermediary party 502. By requesting the dynamic identifier, this signals to the intermediary party 502 that the actor 102 is known to the identifying party 202, and has been authenticated.

In block 906, routine 900 receives the dynamic identifier selected by the intermediary party 502.

In block 908, routine 900 provides the received dynamic identifier to the actor. This enables the actor to provide the dynamic identifier to the transacting party 106, which requests authentication of the dynamic identifier from the intermediary party 502 as described above.

It is to be appreciated that not all of the steps set out in this and the other flowcharts of the accompanying drawings necessarily need to be performed in the order illustrated, described and/or claimed, as will be apparent to skilled person upon reading the disclosure. For example, with reference to FIG. 5, blocks 904 (requesting a dynamic identifier) and 906 (receiving the dynamic identifier) will occur in that order, but both of blocks 904 and 906 may precede block 902, provided the dynamic identifier is not provided to the actor at block 908 unless they have been authenticated. In other words, the blocks may alternatively be performed in the sequence of block 904, block 906, block 902 and block 908. Such variations may be made without departing from the spirit or scope of the disclosure.

The method performed by the transacting party 106 according to the first embodiment of FIG. 6 and FIG. 7, in the form of routine 1000, is illustrated in the flowchart of FIG. 10.

In block 1002, routine 1000 receives an identifier from the actor. In block 1004, routine 1000 sends the identifier received from the actor to the intermediary party 502.

In block 1006, routine 1000 receives authentication of the identity of the actor from the intermediary party if the identifier sent to the intermediary party 502 matches a dynamic identifier previously issued by the intermediary party 502 to the identifying party 202 following authentication of the actor by the identifying party.

A message protocol 1100 according to a second embodiment is illustrated in FIG. 11 (overlaid on the topography of FIG. 5) and FIG. 12 (in sequence diagram form). The second embodiment is generally similar to the message protocol 600 of the first embodiment, except the process is initiated through the transacting party 106 rather than the identifying party 202. Message protocol 1100 may therefore be referred to as a “reverse direction” as opposed to the “normal direction” of message protocol 600. In message protocol 1100, the dynamic identifier is authenticated by the identifying party 202 providing the dynamic identifier to the intermediary party 502 and the intermediary party advising the transacting party 106 that the actor has been authenticated.

In a first step 1102, the actor 102 requests a dynamic identifier, referred to in the diagram as an Enigram™, from the transacting party 106.

In a second step 1104, the transacting party 106 requests the dynamic identifier from the intermediary party 502. The transacting party 106, rather than the identifying party 202, is the requestor in this reverse direction.

In a third step 1202, the intermediary party 502 issues the dynamic identifier by selecting, storing and sending it to the 106.

In a fourth step 1106, the transacting party 106 provides the dynamic identifier to the actor 102.

In a fifth step 1108, the identifying party 202 authenticates the actor 102.

In a sixth step 1110, the identifying party 202 receives the dynamic identifier from the actor 102.

In a seventh step 1112, the identifying party 202 sends the received dynamic identifier to the intermediary party 502, provided the actor 102 has been authenticated.

In an eighth step 1114, the intermediary party 502 receives dynamic identifier, checks it against stored dynamic identifiers and messages the transacting party 106 accordingly. If there is no match, or the matching dynamic identifier has expired, authorization is declined. Otherwise, the intermediary party 502 authenticates the identity of actor 102 to the transacting party 106.

As in the first embodiment, if data is required to complete an identity transaction, the identity authentication system 500 may perform additional data request steps 618, 620, 622, 624. In this second embodiment, the first step 618 of the data request method may be combined with the second step 1104 of the authentication method, and/or the fourth step 624 of the data request method may be combined with the eighth step 1114 of the authentication method.

By way of non-limiting example, the message protocol 1100 may involve an actor 102 who wishes to authenticate their profile with a social media service, as the transacting party 106, based on authentication of their identity using a smartphone app provided by a government authority, acting as the identifying party 202, as a national or federal identification scheme. In this case, the actor 102 will likely have signed on to the social media service, and when requesting authentication the social media service displays a QR-Code dynamic identifier on the display of the actor’s computing device. The actor authenticates themselves on the government smartphone app and scans the QR-Code using the same app. The social media service is subsequently advised by the intermediary party 502 that the user has been authenticated.

In some embodiments, the transacting party 106 and the identifying party 202 may be the same party. The party may also fill the role of the intermediary party 502, or may optionally use an independent intermediary party 502. The disclosed authentication systems and methods may alternatively, or additionally, be used in a single-party scenario. In this scenario the single party communicates with the actor via two different channels to gain a higher level of assurance as to the identity of the actor 102. By way of non-limiting example, an actor might authenticate themselves to a bank call-center by providing a dynamic identifier from a smartphone app, provided by the same bank, that uses biometric authentication, as opposed to what is often a range of security questions regarding age, mother’s maiden name, etc.

The method performed by the intermediary party 502 in the second embodiment of FIG. 11 and FIG. 12, in the form of routine 800, is illustrated in the flowchart of FIG. 8 and is largely as described above. In this second embodiment, however, the transacting party 106 is the requestor and the identifying party 202 is the non-requestor.

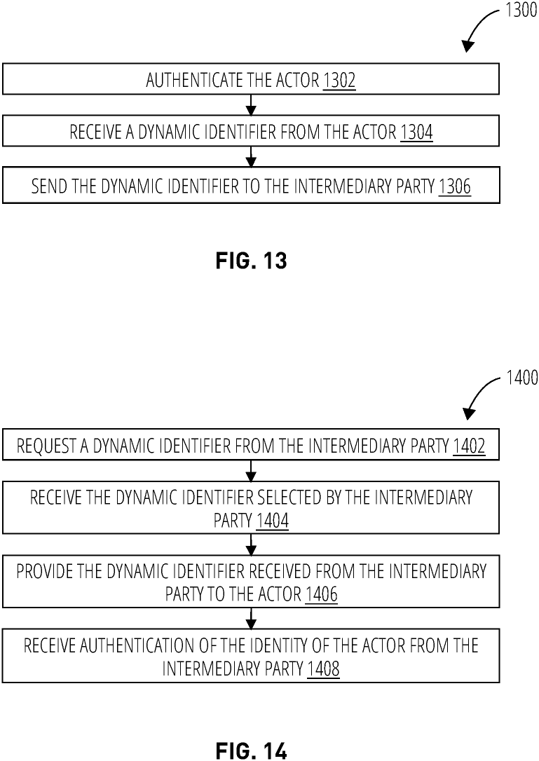

The method performed by the identifying party 202 according to the second embodiment of FIG. 11 and FIG. 12, in the form of routine 1300, is illustrated in the flowchart of FIG. 13.

In block 1302, routine 1300 authenticates the actor. As the identifying party 202 has a preexisting relationship with the actor 102, this may be by way of biometric authentication using an app provided to the actor’s device by the identifying party 202. If the actor 102 cannot be authenticated, the routine 1300 does not proceed to block 1304, and an error message may be displayed to at least the actor 102.

In block 1304, routine 1300 receives a dynamic identifier from the actor. For a legitimate transaction, this will be the same identifier previously requested from the intermediary party 502 by the transacting party 106, then provided to the actor 102 by the transacting party 106.

In block 1306, routine 1300 sends the dynamic identifier received from the actor 102 to the intermediary party 502. Sending the dynamic identifier to the intermediary party 502 signals to the intermediary party 502 that the actor 102 is known to the identifying party 202 and has been authenticated, and enables the intermediary party 502 to determine whether the dynamic identifier received by the identifying party 202 is the same as that issued to the transacting party 106, as described elsewhere.

The method performed by the transacting party 106 according to the second embodiment of FIG. 11 and FIG. 12, in the form of routine 1400, is illustrated in the flowchart of FIG. 14.

In block 1402, routine 1400 requests a dynamic identifier from the intermediary party 502. In response, the intermediary party 502 issues the requested dynamic identifier as described elsewhere.

In block 1404, routine 1400 receives the dynamic identifier from the intermediary party 502.

In block 1406, routine 1400 provides the dynamic identifier received from the intermediary party 502 to the actor 102. This enables the actor 102 to present the dynamic identifier to the identifying party 202 which, after authenticating the actor 102, forwards the dynamic identifier to the intermediary party 502, as described above.

In block 1408, routine 1400 receives authentication of the identity of the actor from the intermediary party, if the intermediary party 502 determines that the dynamic identifier received from the identifying party 202 matches the dynamic identifier previously selected by the intermediary party 502 and provided to the transacting party 106, as described above.

### Networked System

The disclosed identity authentication systems and message protocols may be implemented as a networked system of servers. Throughout the description and claims, the term “server” refers generally to a computer system, whether centralized or distributed, including at least one processor, a memory and a network interface for communicating with another server or a client device in accordance with programmed instructions stored on a non-transitory computer readable medium. The term “memory” refers generally to a component of a computer system configured to store data, whether volatile or non-volatile, fixed or removable, and is intended to encompass at least a cache, random access memory (RAM) module, Universal Serial Bus (USB) flash drive, flash memory card, compact disc (CD), digital versatile disc (DVD), magnetic tape drive and media, hard disk drive (HDD), solid state drive (SSD) and equivalents of any of the foregoing.

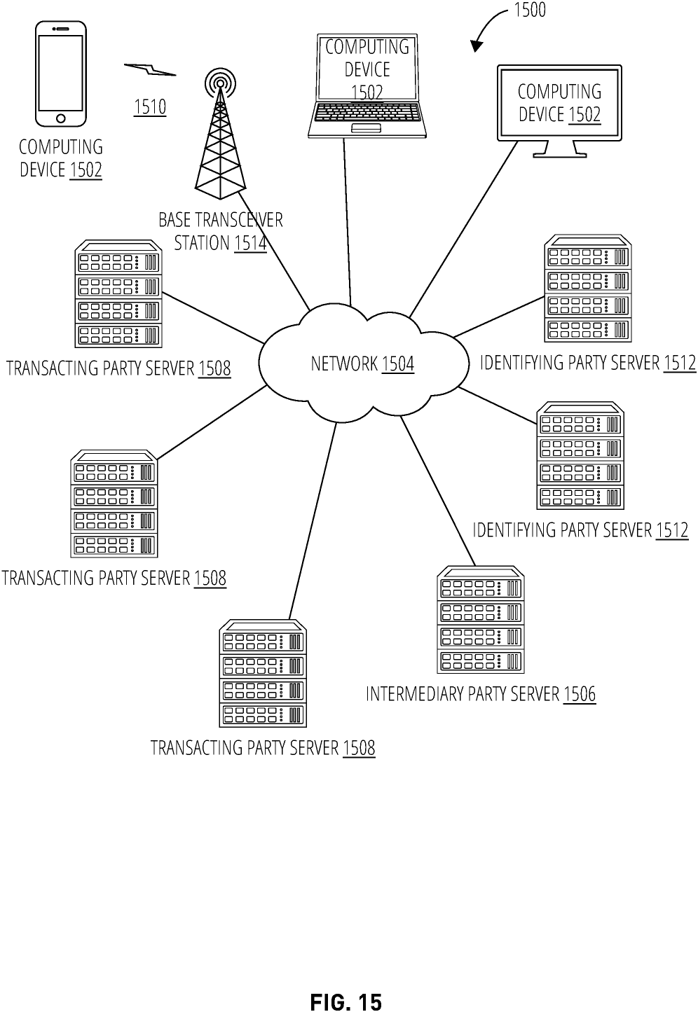

In FIG. 15, a diagrammatic representation of a networked identity authentication system 1500 is shown to include three transacting party servers 1508 each representing a different transacting party, an intermediary party server 1506, two identifying party servers 1512 each representing a different identifying party, and three computing devices 1502 each representing a different actor 102, connected via a data network 1504. The computing devices 1502 may each belong to an actor 102, and may be a smartphone, laptop, desktop personal computer or the like. Alternatively, one or more of the computing devices 1502 may represent a point-of-sale device operated by an employee of the transacting party 106, or a self-service kiosk or other device in possession of the transacting party 106 but operated by an actor 102. The computing devices 1502 may have a wired and/or wireless connection to the network 1504, such as a smartphone in wireless communication with a base transceiver station 1514 via a wireless telecommunications network 1510. Network 1504 represents, without limitation, a local area network (LAN), wide area network (WAN), Internet, or combinations thereof. Communications between the intermediary party server 1506 and each of the transacting party servers 1508 and identifying party servers 1512 may be encrypted and/or via a virtual private network (VPN).

In practice, the networked identity authentication system 1500 may include any number of transacting party servers 1508, identifying party servers 1512, and actors’ computing devices 1502.

### Dynamic Identifier

Each of the above embodiments described above involves the use of a dynamic identifier. The identifier is dynamic in that it is has a limited life span and is used for a single transaction between the actor 102 and transacting party 106. It may therefore be thought of as a one-time/single-use password. In some embodiments, there may be some provision for reuse of identifiers. This will generally be temporally distant (i.e., only after expiry of the previous use of the dynamic identifier) and optionally only for use by a different actor 102, transacting party 106 and/or identifying party 202. The terms “dynamic identifier,” “single transaction” and the like are intended to encompass such reuse.

Because a dynamic identifier is used for a single transaction and has a limited life span, it has little to no value if stolen. By contrast, solutions that use a static identifier such as a username and password combination are inherently insecure as such credentials can be easily stolen and reused, potentially with multiple transacting parties if the actor uses the same password.

In some embodiments, the dynamic identifier is selected by the intermediary party 502 using, at least in part, a random number generator or similar method to produce a value in a large range that cannot be inferred from any other data and, given the limited life span of the dynamic identifier, cannot practically be guessed or attacked by brute force. The number of possible permutations in the dynamic identifier should be orders of magnitude greater than the number of dynamic identifiers which are expected to be active at any one time. For example, the number of possible dynamic identifier permutations may exceed the anticipated or current number of active dynamic identifiers by at least two, preferably at least three, more preferably at least six, and yet more preferably at least 9 orders of magnitude.

Possible types of dynamic identifiers include, without limitation:
a numeric code (e.g., “346234”)
an alphanumeric code (e.g., “4gh7p37w”)
a character string (e.g., “456dhrg#$dd@35GTT” or “%^&@*^@$%%^&″”)
a graphic
a series of audible sounds
a physical object, or
combinations of the above.

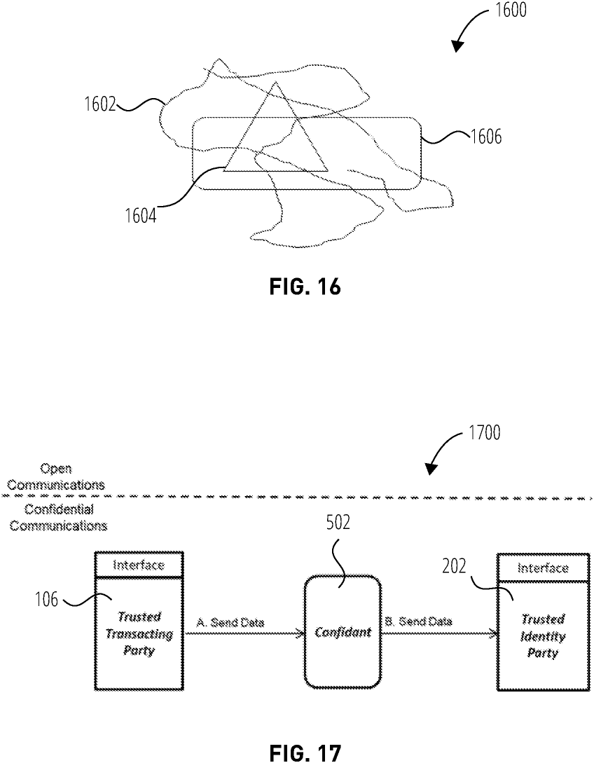

An example of a graphic 1600 which may be used as a dynamic identifier is shown in FIG. 16. The graphic includes an arrangement of a line 1602, triangle 1604 and rectangle 1606. An alternative graphic dynamic identifier may comprise the same shapes in different proportions or relative positions, alternative shapes, or additional shapes. In other embodiments, the graphic may be a rebus.

An example of a physical object which may be used as a dynamic identifier is a three-dimensional item produced by additive manufacturing, such as by three-dimensional (3D) printing.

The use of a randomly-generated dynamic identifier avoids the vulnerability of user-selected passwords which frequently incorporate words or numbers which are memorable, significant or convenient for an actor (such as a pet’s name, child’s name, birthplace, sports team, or “Password”), which can be more easily guessed.

As demonstrated by the message protocol 600 and message protocol 1100 described above, the dynamic identifier has the following inherent meanings once authenticated by the intermediary party 502:
1. identity, i.e., the actor 102 presenting the authenticated dynamic identifier is known to the identifying party 202
2. authentication, i.e., the identity of the actor 102 has been authenticated by the identifying party 202, and
3. the two channels of the identity transaction are co-located, i.e., a single actor is in communication with both the identifying party 202 and the transacting party 106.

The dynamic identifier may have characteristics of medium, presentation, size, uniqueness, life span, reusability and entry method. In some embodiments, for every identity transaction supported between a specific identifying party and transacting party, a specific type of dynamic identifier, having certain characteristics, may be specified.

Possible presentation methods include, without limitation, short message service (SMS) text message, email, graphics, radio signals readable by near field communication (NFC), a machine-readable optical symbol such as a QR code or Universal Product Code (UPC) barcode, audio signals, or combinations thereof.

The complexity of the dynamic identifier may be selected, or varied, to balance the needs of communicability, convenience and security. By way of non-limiting example, a six-digit numeric code offers 10⁶ possible permutations, while a twelve-digit case-sensitive alphanumeric code offers 62¹² permutations and may be used for transactions requiring greater security. In some embodiments, such as where the presentation method is an NFC signal or a QR code, for example, there may be no additional inconvenience to the actor or parties in the use of a complex dynamic identifier, and a relatively complex dynamic identifier may be used for every transaction. Use of a complex dynamic identifier may also avoid the possible need for reuse of dynamic identifiers.

In some embodiments, each dynamic identifier has a limited life span which is based upon the identity transaction security needs. For a high value identity transaction, the life span may be mere seconds, while for a low value or asynchronous identity transaction the life span may be a number of days or even weeks.

A single-use randomly-generated complex dynamic identifier with a limited life span is very challenging to guess or successfully attack by brute force.

In some embodiments, the dynamic identifier may also incorporate a checksum, cyclic redundancy code (CRC) or similar which may be used to identify attempts to guess a dynamic identifier, or identify a brute force attack.

In some embodiments, a dynamic identifier will be used for a single identity transaction only. However, in certain other embodiment the dynamic identifier may be re-used in another transaction. Such re-use may be temporally distant and/or involve different parties.

In some embodiments, entry methods for the dynamic identifier may optionally be specified as being able to be entered using only a specific method or methods. For example, use of a QR code which is only able to be optically scanned may be specified.

### Relationship Administration

The advent of open banking and consumer data rights (CDR) has highlighted that identity transactions, especially identity relationship transaction (IRTs), are a prominent aspect of data sharing initiatives. Embodiments of the present disclosure provide a solution to enabling such data sharing through identity relationship transactions that enable the swapping of data, such as identity tokens, that are then used as proof of authority for data sharing. In some embodiments, this can be extended to provide an administrative support solution for relationship management on an ongoing basis either as a solution that accepts authorized customer directives via identifying parties or potentially directly to customers themselves.

In one embodiment, the intermediary party 502 may hold details of relationships between an actor’s accounts with a utility company and a bank for bill presentment delivery. The actor 102, through an identity relationship transaction, authorizes a utility to send their bills to their account at their bank. The intermediary party 502 records these relationships and, when instructed by the actor 102, can alter or modify these relationships. This can be achieved through instructions delivered via an identifying party 202 or directly through an interface of the intermediary party 502, such as a website.

### On-behalf Message Switching

Referring to FIG. 17, in one embodiment an identity authentication system 1700 may be extended to provide on-behalf message switching. As described in relation to the messaging protocols above, the result of an identity relationship transaction may be that the intermediary party 502 retains knowledge of the on-behalf relationship. In the example above, a utility (as the transacting party 106) might provide bills to the intermediary party 502 who would forward them on to the relevant bank (as the identifying party 202).

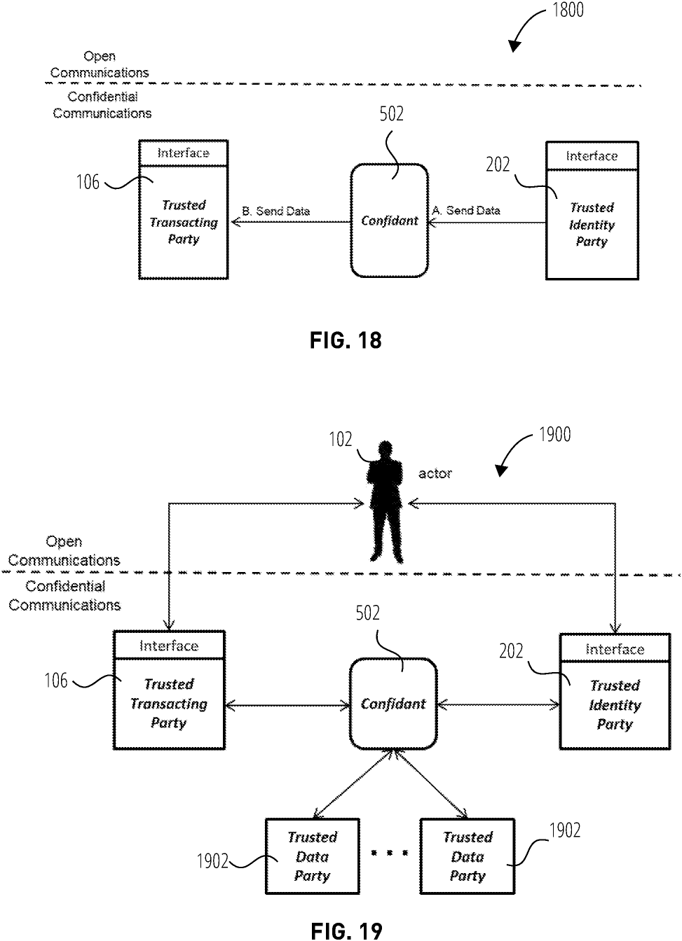

Referring to FIG. 18, there is shown a further embodiment in which an identity authentication system 1800 provides on-behalf message switching from the identifying party 202 to the transacting party 106.

### Trusted Data Providers

Referring to FIG. 19, a further embodiment of an identity authentication system 1900 is extended by the inclusion of one or more trusted data parties 1902. A relationship can be created between the identifying party 202 and a trusted data parties 1902 at the actor’s behest through an identity relationship transaction. In this case, the intermediary party 502 remembers the relationship. In future identity transactions, the intermediary party 502 can access the trusted data party 1902 to gain more information which may be required by the transacting party 106.

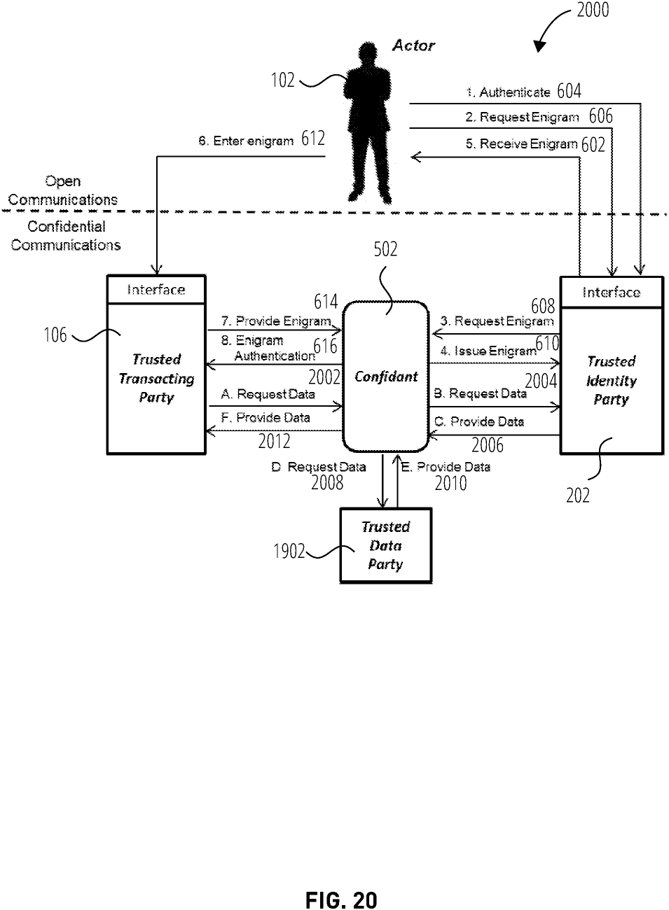

Referring to FIG. 20, an example embodiment of a message protocol 2000 is shown. As shown, the authentication message protocol may be the same as that of message protocol 600, including steps 604, 606, 608, 610, 602, 612, 614 and 616 as described above with respect to the embodiment of FIG. 6. Alternatively, the authentication message protocol may be the same as that of message protocol 1100 as described above with respect to FIG. 11.

The data message protocol in this embodiment has six steps. In a first step 2002, the transacting party 106 requests additional data from the intermediary party 502. In a second step 2004, the intermediary party 502 requests the additional data from the identifying party 202. In a third step 2006, the identifying party 202 provides additional data to the intermediary party 502. In a fourth step 2008, the intermediary party 502 requests additional data from the trusted data party 1902. In a fifth step 2010, the trusted data party 1902 provides additional data to the intermediary party 502. In a sixth step 2012, the intermediary party 502 provides the additional data to the transacting party 106.

Although a single trusted data party 1902 is shown in FIG. 20, multiple trusted data parties 1902 can participate in a single identity transaction.

A number of variations to the message protocol 2000 are possible. For example, and without limitation, the fifth step 2010 and the fourth step 2008 may be omitted if the requested data is provided by the identifying party 202 in the third step 2006. Similarly, the second step 2004 and the third step 2006 may be omitted if the requested data is available from the trusted data party 1902. Certain data messages may also be combined with certain authentication messages as previously described in relation to the messaging protocol embodiments of FIG. 6 and FIG. 11.

An example application of an identity transaction with a trusted data party is when an independent identifying party 202 creates an actor database through know your customer (KYC) processes and with biometric authentication in a smartphone. An identity account transaction is executed by an actor 102 through the independent identifying party with a District Health Board (DHB) to create the relationship of the DHB being a trusted data party 1902, and the intermediary party 502 remembers the relationship. When an actor 102 later wishes to provide their Covid-19 status to a transacting party 106, they authenticate through the identifying party’s smartphone app and request a dynamic identifier. The dynamic identifier is provided to a tablet app provided by a transacting party 106 which sends the dynamic identifier to the intermediary party 502. Once the intermediary party 502 finds that the dynamic identifier is valid, rather than asking the identifying party 202 for data, the District Health Board as the trusted data party 1902 may be requested to provide the data which is then passed back to the transacting party 106.

### Application Programming Interface (API)-Based Implementation

The disclosed transacting party 106, intermediary party 502 and identifying party 202 may be programmed to communicate with each other by way of an application programming interface (API).

In some embodiments, there may be APIs provided for at least eight scenarios based on:
1. the function being performed: “identity” or “connect”
2. the direction of the transaction: “normal” (e.g., FIG. 6) or “reverse” (e.g., FIG. 11), and
3. the mode of the transaction: dual or optimized.

Identity permission transactions, identity account transactions, and identity relationship transactions (IPTs, IATs, and IRTs) can be accomplished through two different types of function. The “identity” type of function is a general type in which identity confirmation, through identification and authentication, is followed by data exchange. The data exchange supports IPTs, IATs and IRTs through providing data to a transacting party who then analyses and/or uses the data.

The “connect” function type is a variety used when the identity authentication system is providing relationship management. In this IRT case, some form of identity tokens are received from both the transacting party and the identifying party. The connect function type specifically allows for this token exchange.

Two sets of API functions may be provided to accommodate each of the “normal” direction (in which the transaction is initiated between the actor 102 and the identifying party 202, e.g., FIG. 6) and “reverse” direction (in which the transaction is initiated between the actor 102 and the transacting party 106, e.g., FIG. 11). In other embodiments, however, the identity authentication system may be configured to operate in only one of the two directions.

“Mode” refers to either a dual mode, in which identification/authentication is followed by data exchange, or an optimized mode, in which data is preloaded in requests to minimize the number of API calls needed and to increase efficiency, as described above.

In themselves, the API calls provide a degree of verification because they can only be called from specific points. Additionally, every identity transaction may have a transaction type, txn_type, that has a definition held in the intermediary party server that may include what nodes can use the transaction and the allowable data in the transaction.

Each specific identity transaction may be assigned a transaction number, txn_number. This number is used throughout the sequence of APIs to achieve stateful processing.

Eight API scenarios are described below along with the relevant APIs used in each scenario. Some APIs are used in multiple scenarios. The term “enigram″™ refers to the dynamic identifier, the term “node” refers to a particular transacting party server or identifying party server, and the output parameters of each API function are indicated in italics.

### Identity / Normal Order / Dual Messages

get_enigram(node, txn_type, txn_number, enigram) - a node may call this API function to request a dynamic identifier (enigram) from the intermediary party 502. A txn_number is created and this is returned to the requesting node which, in this scenario, is an identifying party 202. The txn_number is not required for the identity authentication system to function, but may be provided to the requesting node to provide an audit trail.

present_enigram(node, txn_type, enigram, txn_number, validation status) -a node, in this scenario a transacting party 106, may use this API function to present a dynamic identifier (enigram) to the intermediary party 502 for authentication. In this case, a request_payload is anticipated and hence a txn_number is provided to the presenting node for use when the validation_status is successful.

request_payload(node, txn_type, txn_number, validation_status, payload) - a transacting party 106 may call this API function to request additional data, as described elsewhere.

get_payload(node, txn_type, txn_number, validation_status, payload) -during the processing of a request_payload API call by the intermediary party 502, the intermediary party 502 will get the payload from the identifying party through this get_payload API function.

### Connect / Normal Order / Dual Messages

In this scenario, the same get_enigram and present_enigram API functions are used as described with respect to the preceding scenario, but the following API functions are also used.

present_token(node, txn_type, txn_number, _ttp_id_token) - a transacting party 106 may call this API function to present an identification token to the intermediary party 502 as half of the connection mapping to be maintained by the intermediary party 502.

request_token(node, txn_type, txn_number, tip_id_token) - if the dynamic identifier is authenticated and an identification token provided to the intermediary party 502 by a transacting party 106, the intermediary party 502 may use this API function to request an identification token from the identifying party 202.

### Identity / Normal Order / Optimized Messages

get_enigram_opt(node, txn_type, payload, txn_number, enigram) - this API function performs the role of both of the get_enigram and get_payload API functions described above. The requesting node, in this scenario an identifying party 202, assumes that the dynamic identifier will be successfully transmitted and returned for authentication, and provides the payload to the intermediary party 502 in advance. The rest of the processing remains the same.

present_enigram_opt(node, txn_type, enigram, txn_number, validation_status, payload) - this API performs the role of both of the present_enigram and request_payload API functions described above. The presenting node, in this scenario a transacting party 106, provides the dynamic identifier to the intermediary party 502 and receives a txn_number, a validation_status, and a payload if the presented dynamic identifier is successfully authenticated by the intermediary party 502.

### Connect / Normal Order / Optimized Messages

cget_enigram_opt(node, txn_type, tip_id_token, txn_number, enigram) - this API function performs the role of both of the get_enigram and get_token API functions described above. The requesting node, in this scenario an identifying party 202, assumes that the dynamic identifier will be successfully transmitted and authenticated, and provides the identification token to the intermediary party 502 in advance. The rest of the processing remains the same.

cpresent_enigram_opt(node, txn_type, enigram, ttp_id_token, txn_number, validation status) - this API function performs the role of both of the present_enigram and request_token API functions described above. The presenting node, in this scenario a transacting party 106, provides the dynamic identifier and an identification token to the intermediary party 502 and, if the dynamic identifier is successfully authenticated, receives a txn_number and a validation_status.

### Identity / Reverse Order / Dual Messages

In this scenario, the two payload API functions described above are used in the same way as described above. The following API functions are used in place of the corresponding API functions for the normal direction.

get_enigram_rev(node, txn_type, txn_number, enigram) - this API function is called by a transacting party 106 to request a dynamic identifier from the intermediary party 502. The API function otherwise works in the same manner as get_enigram. The separate API function enables the transaction direction to be checked.

provide_enigram_rev(node, txn_type, enigram, txn_number, validation status) - this API function is called by an identifying party 202 to deliver a dynamic identifier to the intermediary party 502 for authentication. The txn_number and validation_status may be provided to the identifying party 202 for audit trail purposes.

authenticate_enigram_rev(node, txn_type, txn_number, validation status) -this API function may be used to confirm authentication of the dynamic identifier received from an identifying party 202 to the relevant transacting party 106.

### Connect / Reverse Order / Dual Messages

In this scenario, the two identification token API functions, present_token and request_token, are used as described above with respect to the connect / normal order / dual messages scenario, but the get_enigram_rev, provide_enigram_rev and authenticate_enigram_rev API functions described with respect to the preceding scenario are used in place of the get_enigram and present_enigram API functions of the normal order scenario.

### Identity / Reverse Order / Optimized Messages

get_enigram_rev_opt(node, txn_type, txn_number, enigram) - this API function is used in the same manner as get_enigram_opt, but is called by the transacting party 106 and is distinguished by its own procedure call to enable the transaction direction to be checked.

provide_enigram_rev_opt(node, txn_type, enigram, payload, txn_number, validation status) - in the optimized reverse scenario, the identifying party 202 delivers the enigram to the intermediary party 502 and, assuming that the enigram will be authenticated, also includes the payload. The txn_number and validation_status may be provided to the identifying party 202 for audit trail purposes.

authenticate_enigram_rev_opt(node, txn_type, txn_number, validation_status, payload) - this API function may be used to confirm authentication of the dynamic identifier received from an identifying party 202 to the relevant transacting party 106, and returns both the validation_status and the payload.

### Connect / Normal Order / Optimized Messages

cget_enigram_rev_opt(node, txn_type, ttp_id_token, txn_number, enigram) -this API function may be used in the same manner as get_enigram_rev, other than the addition of passing an identification token.

cprovide_enigram_rev_opt(node, txn_type, enigram, tip_id_token, txn_number, validation_status) - in this scenario, an identifying party 202 delivers the dynamic identifier to the intermediary party 502 and, assuming that the dynamic identifier will be authenticated, also includes the identification token. A txn_number and validation_status may be provided to the identifying party 202 for audit trail purposes.

authenticate_enigram_rev_opt(node, txn_type, txn_number, validation_status, payload) - this API function returns both the validation_status and the payload to a transacting party 106.

### Further Example Applications

Various further example embodiments are briefly described below to illustrate, without limitation, potential applications and advantages of the disclosed systems and methods.

In one embodiment, an identity authentication system may be used to authenticate users of a social media platform, as the transacting party. The social media platform may enter a service agreement with an intermediary party and/or identifying party. The social media platform can request and display a dynamic identifier through their service to each user of the platform, and the user can scan that dynamic identifier using a smartphone app provided by the identifying party after or before appropriate identification and authentication. Once completed, the user’s profile on the social media platform would have the same authentication quality as the identifying party’s customer authentication quality, achieved with a highly efficient customer process.

In another embodiment, the system may utilize offline channels such as by telephone using a public switched telephone network (PSTN) or mobile telephone network. By way of non-limiting example, a customer of a co-operative who wishes to make a purchase at a merchant of the co-operative calls the merchant’s call-center and when prompted provides a dynamic identifier verbally that was supplied to the customer from an identifying party through an app on the customer’s smartphone, after appropriate identification and authentication. A similar process can be used in a physical store by the merchant scanning a UPC barcode displayed on the customer’s smartphone after appropriate identification and authentication.

The foregoing examples illustrate what may be termed a synchronous mode, in which communication between the parties occurs near-instantaneously. In another embodiment, an identity authentication system may operate in an asynchronous mode. By way of non-limiting example, a utility might wish to connect to a bank for bill presentment. To do this, a connection is established by the utility requesting dynamic identifiers for multiple customers and printing these dynamic identifiers on respective utility bills. When a customer receives such a bill, the dynamic identifier can be entered into a bank interface, such as a website, after appropriate identification and authentication. The customer is given some days or weeks to complete this identity transaction. This can be achieved as a dynamic identifier can have a life span of days or weeks, thereby enabling such asynchronous operation.

In a further example embodiment, a transaction requiring high security, such as the opening of an account with a bank, can take advantage of the ability to customize transactions. For example, a relatively complex dynamic identifier can be specified, the type of channels and devices used to communicate the dynamic identifier can be restricted, the life span of the dynamic identifier can be kept to a minimum (for example, 30 seconds or less), and the purpose that the dynamic identifier can be used for can be limited. By reducing the scope, a transaction such as opening a bank account can be made highly secure.

Full-emulation man-in-the-middle attacks are generally among the more difficult attacks to counter. These attacks only occur online and potentially provide a fraudster with access to services. According to another example embodiment, an identity authentication system may repeat the authentication process to confirm the intent of a customer. Because of the efficiency of the authentication, this presents relatively little inconvenience for the customer. For example, in the co-operative example above, a customer ordering a product would be asked to go through a second identification and authentication process which includes prompting of the intended actions through the identifying party interface, at the end of an ordering session. With such a second step, such man-in-the-middle attacks are highly unlikely to succeed, as they require a co-temporal social attack on the customer who has already experienced an interface failure and hence may already be suspicious of what is occurring.

In a further example embodiment, anonymity of the actor with respect to the transacting party may be maintained. Identity transactions are often ‘named’ in the sense that the objective is to identify the customer. But for some transactions, such as a Covid-19 health check, anonymity of identity transactions may be preferred or required. The disclosed systems and methods enable this, as a Covid-19 health check transaction can be configured to not pass back any identity information to the transacting party, which may be a cinema, a sports arena, or an airport, by way of non-limiting example. Rather, only the Covid-19 test status, vaccination status or the like of the actor may be provided to the transacting party.

From the foregoing it will be appreciated that systems and methods are provided which allow for secure and efficient multi-party authenticated identification. In at least some embodiments this is permitted by the use of a dynamic identifier with a messaging protocol used in a circle of trust, supported by a configuration method. This method allows dynamic identifiers to be specified and security parameters to be set for a specific use case and also down to the level of a specific transaction. The dynamic identifier used can be made more complex when higher levels of security are desirable, and the configuration parameters can be set at higher levels when more security is desired. These higher settings do not make any transaction less efficient. Other identity solutions add more process complexity to add more security, whereas the disclosed systems and methods provide for customer efficiency and restricts identity transactions where higher security is desired.

Embodiments of the disclosed solution provide one or more of the advantages of convenience for customers, suitability for use with any channel (both online and offline), synchronous and asynchronous modes, security, optional anonymity, fraud prevention and support for all identity transactions.

Customer efficiency advantages are evident by comparing the disclosed systems and methods with alternative solutions which require an initial identification and authentication, followed by a second identification and authentication and then the transfer of a confirmation code. Embodiments of the present disclosure, on the other hand, essentially require only an initial identification and authentication followed by entry of a dynamic identifier into a second channel.

Embodiments of the disclosed systems and methods also reduce fraud potential through the use of dynamic identifier. Credentials are entered through the identifying party which becomes highly used and is most easily fortified. Entering a dynamic identifier at a transacting party has no risk of credential theft as credentials are not involved. Credentials are entered at the identifying party and this channel can be made secure through the use of hardened apps and avoiding local data on insecure personal electronic devices. Such precautions provide the best way of reducing identity fraud as identity transactions do require the use of some credentials. The disclosed systems and methods minimize the use of credentials, avoid credential entry at possible insecure phishing sites, and provides the opportunity to create highly secure interfaces that can then be reused in multiple scenarios.

In some embodiments, the disclosed methods may be implemented in software instructions stored on a non-transitory computer-readable medium that, when processed by a computer, configure the computer to perform one or more of the disclosed methods.

Throughout the description and claims, the terms “comprise,” “include,” and variants are used in an inclusive or non-exhaustive sense, i.e., in the sense of “including, but not limited to,” and unless the context clearly requires otherwise, are not intended to be interpreted in an exclusive or exhaustive sense, i.e., “consisting only of.”

What is claimed is:

1. A networked identity authentication system for authenticating an identity of an actor to a transacting party based on a pre-existing relationship between the actor and an identifying party, the networked identity authentication system comprising a transacting party server of the transacting party, an identifying party server of the identifying party, and an intermediary party server of an intermediary party in secure network communication with the transacting party server and the identifying party server, each of the transacting party server, identifying party server and intermediary party server comprising a respective processor, memory and network interface, wherein:
the processor of at least one of the transacting party server and the identifying party server is configured to:
request, via the respective network interface, a dynamic identifier from the intermediary party server,
receive, via the respective network interface, the dynamic identifier from the intermediary party server, and
provide the dynamic identifier to the actor;
the processor of at least the other of the transacting party server and the identifying party server is configured to:
receive an identifier from the actor, and
send, via the respective network interface, the identifier to the intermediary party server for authentication;
the processor of the identifying party server is further configured to:
authenticate the actor based on the pre-existing relationship between the actor and the identifying party;
the processor of the transacting party server is further configured to:
receive, via the respective network interface, a confirmation of authentication from the intermediary party server; and
the processor of the intermediary party server is configured to:
receive a request for the dynamic identifier from a requestor, the requestor comprising one of the transacting party server and the identifying party server, and a non-requestor comprising the other of the transacting party server and the identifying party server,
select the dynamic identifier,
store the dynamic identifier in the memory of the intermediary party server,
send, via the respective network interface, the dynamic identifier to the requestor,
receive, via the respective network interface, the identifier from the non-requestor,
authenticate the identifier received from the non-requestor by comparing it with the stored dynamic identifier, and
send, via the respective network interface, the confirmation of authentication to the transacting party server if the identifier matches the stored dynamic identifier.

2. (canceled)

3. The networked identity authentication system of claim 1, wherein:
the processor of the identifying party server is configured to:
request the dynamic identifier from the intermediary party server,
receive the dynamic identifier from the intermediary party server, and
provide the dynamic identifier to the actor;
the processor of the transacting party server is configured to:
receive the identifier from the actor, and
send the identifier to the intermediary party server; and
the processor of the intermediary party server is configured to:
receive the request for the dynamic identifier from the identifying party server,
send the dynamic identifier to the identifying party server, and
receive the identifier from the transacting party server.

4. The networked identity authentication system of claim 1, wherein:
the processor of the transacting party server is configured to:
request the dynamic identifier from the intermediary party server,
receive the dynamic identifier from the intermediary party server, and
provide the dynamic identifier to the actor;
the processor of the identifying party server is configured to:
receive the identifier from the actor, and
send the identifier to the intermediary party server; and
the processor of the intermediary party server is configured to:
receive the request for the dynamic identifier from the transacting party server,
send the dynamic identifier to the transacting party server, and
receive the identifier from the identifying party server.

5. The networked identity authentication system of claim 1, wherein:
the processor of the transacting party server is further configured to:
request, via the respective network interface, additional data from the intermediary party server, and
receive, via the respective network interface, the additional data from the intermediary party server; and
the processor of the intermediary party server is further configured to:
receive, via the respective network interface, the request for the additional data from the transacting party server,
request, via the respective network interface, the additional data from the identifying party server,
receive, via the respective network interface, the additional data from the identifying party server, and
send, via the respective network interface, the additional data to the transacting party server; and
the processor of the identifying party server is further configured to:
receive, via the respective network interface, the request for the additional data from the intermediary party server,
retrieve the additional data from the memory of the identifying party server, and
send, via the respective network interface, the additional data to the intermediary party server.

6-7. (canceled)

8. The networked identity authentication system of claim 5, wherein the additional data comprises one or more of the actor’s:
security level,
authorization rights,
access privileges,
age entitlements,
legal name,
address,
bank account number,
medical status,
telephone number,
email address,
birthdate,
driver’s license number, and
passport number.

9-12. (canceled)

13. The networked identity authentication system of claim 1, wherein the processor of the intermediary party server is configured to select the dynamic identifier by randomly generating at least a portion of the dynamic identifier as one or more of a character string, graphic, audible sound, or physical object.

14. (canceled)

15. The networked identity authentication system of claim 1, wherein the processor of at least one of the transacting party server, the identifying party server and the intermediary party server is configured to encode the dynamic identifier as a machine-readable optical symbol for presentation to the actor via a display or printer of at least one of the transacting party server or the identifying party server.

16. The networked identity authentication system of claim 15, wherein the processor of at least one of the transacting party server, the identifying party server and the intermediary party server is configured to decode the identifier from the machine-readable optical symbol received from an optical sensor of at least one of the transacting party server or the identifying party server.

17. (canceled)

18. The networked identity authentication system of a claim 1, wherein the dynamic identifier comprises a numeric code, the processor of at least one of the transacting party server and the identifying party server is configured to provide the numeric code to the actor, and the processor of at least the other of the transacting party server and the identifying party server is configured to decode the numeric code from at least one of a voice signal or a dual tone multi frequency (DTMF) signal received from the actor via a telecommunications network.

19. The networked identity authentication system of claim 1, wherein the transacting party server and the identifying party server comprise a single server, and a processor of the single server is configured to provide the dynamic identifier to the actor and receive the identifier from the actor via two different channels.

20-23. (canceled)

24. The networked identity authentication system of a claim 1,wherein the processor of the intermediary party server is further configured to perform an additional identity check by comparing selected actor profile data stored by each of the transacting party server and the identifying party server.

25. (canceled)

26. The networked identity authentication system of claim 1, wherein the processor of the intermediary party server is further configured to monitor operation of the networked identity authentication system to identify an attempt to subvert security of the networked identity authentication system by identifying one or more of: .
re-use of the dynamic identifier,
a fake identifier,
a guessed identifier.

27-32. (canceled)

33. The networked identity authentication system of claim 1, wherein the processor of the identifying party server is configured to authenticate the actor based on the pre-existing relationship between the actor and the identifying party by biometric authentication.

34-36. (canceled)

37. The networked identity authentication system of a claim 1, further comprising a data server of a trusted data party in secure network communication with the intermediary party server, wherein:
the processor of the intermediary party server is configured to:
request, via the respective network interface, additional data from the data server,
receive, via the respective network interface, the additional data from the trusted data server, and
send, via the respective network interface, the additional data to the transacting party server.

38. An intermediary party server for use in a multi-party networked identity authentication system, the intermediary party server comprising:
a processor,
a memory, and
a network interface,
wherein the memory comprises a non-transitory computer-readable storage medium including instructions that, when processed by a computer, configure the intermediary party server to:
select a dynamic identifier,
store the dynamic identifier in the memory,
send the dynamic identifier to a first party via the network interface,
receive an identifier from a second party via the network interface,
compare the identifier with the dynamic identifier stored in the memory, and
send an authentication message to at least one of the first party or the second party if the identifier matches the dynamic identifier.

39. The intermediary party server of claim 38, wherein the processor is further configured to:
determine whether the identifier was received within a specified period from selecting, storing, or sending the dynamic identifier, and
send the authentication message only if the identifier matches the dynamic identifier and the identifier was received within the specified period.

40. The intermediary party server of claim 38, wherein the processor is further configured to select the dynamic identifier by randomly generating at least a portion of the dynamic identifier.

41. The intermediary party server of claim 38, wherein:
the first party comprises an identifying party responsible for authenticating an actor before providing the dynamic identifier to the actor,
the second party comprises a transacting party responsible for receiving the identifier from the actor and sending the identifier to the intermediary party server for authentication, and
the processor is configured to send the authentication message to the transacting party.

42. The intermediary party server of claim 38, wherein:
the first party comprises a transacting party responsible for providing the dynamic identifier to an actor,
the second party comprises an identifying party responsible for authenticating the actor, receiving the identifier from the actor and sending the identifier to the intermediary party server, and
the processor is configured to send the authentication message to the transacting party.

43-54. (canceled)

55. The intermediary party server of claim 38, wherein:
at least one of the first party and the second party is responsible for authenticating an actor, and
the intermediary party server does not communicate directly with the actor.
